(19) United States
(12) Patent Application Publication
(10) Pub. No.: US 2010/0206325 A1
(43) Pub. Date: Aug. 19, 2010

(54) Bracemate flosser

(76) Inventor: Inma Lacross, Chesapeake, VA (US)

Correspondence Address: Inma Lacross, 813 Poplar Forest CT, Chesapeake, VA, 23322, US

(21) Appl. No.: 12/378,631

(22) Filed: Feb. 18, 2009

(51) Int. Cl. A61C 15/04

(52) U.S. Cl. 132/323

(57) ABSTRACT

A dental flossing device specifically designed to accommodate flossing for persons with common orthodontic braces where the braces consist of metal wires supported by metal or ceramic brackets cemented to the tooth surface. The flosser is a flossing device consisting of an accommodating handle with grip and a U-shaped extension to which dental floss is tensely attached to each end. The flosser includes narrow floss-holding extensions which fit beneath the brace wire and the tooth surface and its angled handle which comfortably permits access to rear teeth.

### TECHNICAL FIELD

This invention concerns oral hygiene, particularly interdental flossing for persons with orthodontic devices consisting of a wire strand attached to the tooth surface with brackets (braces).

### BACKGROUND OF THE INVENTION

Flossing is an extremely important part of the oral hygiene regimen but persons with braces don't always comply due to the obstacle that the metal wire poses. The commonly accepted method of flossing for persons with braces consists of threading the floss above the brace line, through the interdental space, and then grabbing the floss as it protrudes lingually to floss that space. This labor intensive method must be repeated for each interdental space, over and over until each space is flossed. And currently available hand-held flossers do not work for persons with braces because the wire obstructs the insertion of the flosser to the gum line. The overall difficulty leads to non-compliance with flossing which is particularly noted in children and teens with braces. Unfortunately after a two to three year period of wearing braces many of the newly straightened teeth will be riddled with cavities.

This invention seeks to meet the flossing needs of persons with braces and to increase flossing compliance, particularly children, teens, and young adults by making flossing easy.

The invention will be more fully described by reference to the following drawings.

### BRIEF DESCRIPTION OF THE DRAWINGS

FIG. 1 is a sketch depicting the angle of the handle to the flosser. This angular relation is maintained in each of the three versions of the flosser.

FIG. 2 is a sketch of FIG. 1 whereas the flosser is applied to teeth with braces.

FIG. 3 is a sketch of FIG. 2 where an interproximal (proxy) brush is added to the flosser.

FIG. 4 is a sketch of finger-held version of the flosser.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

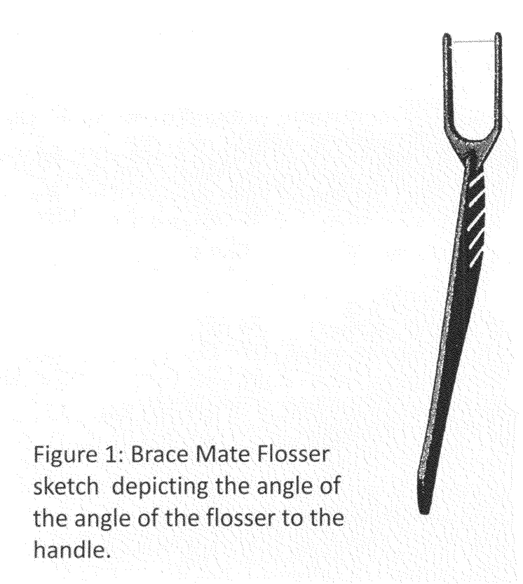

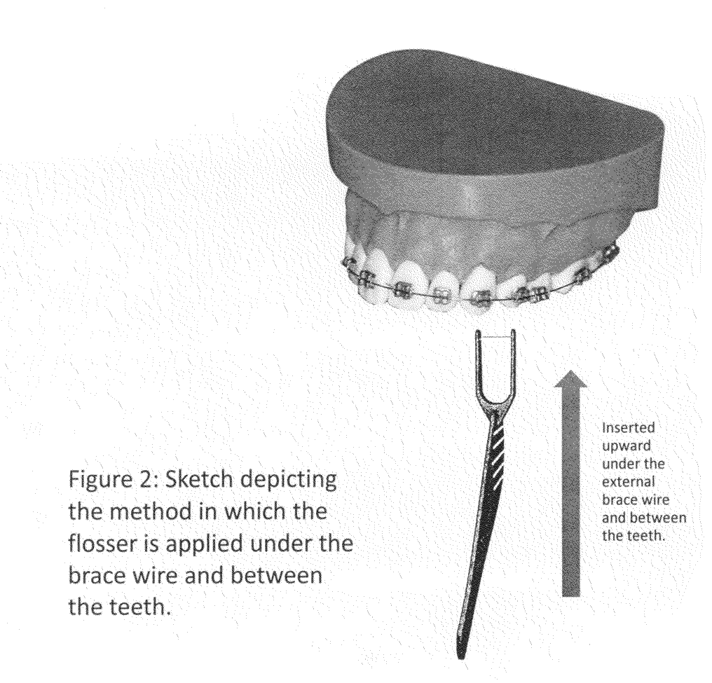

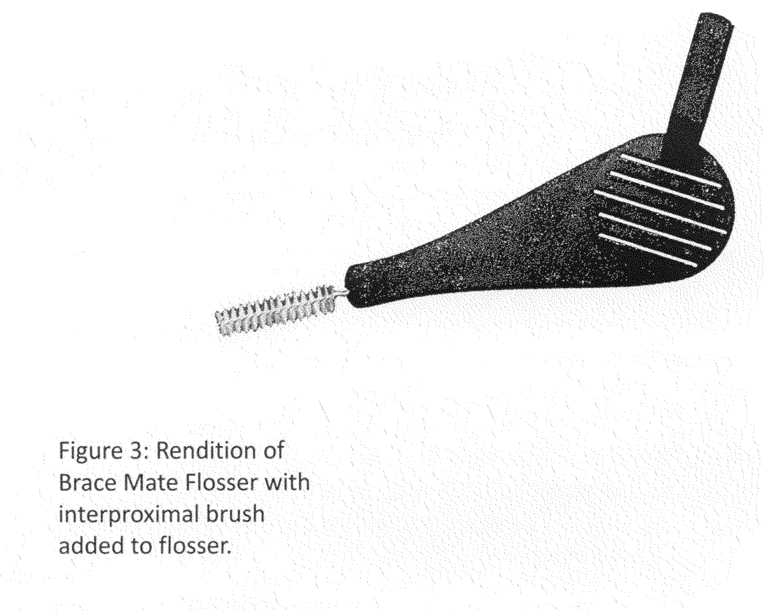

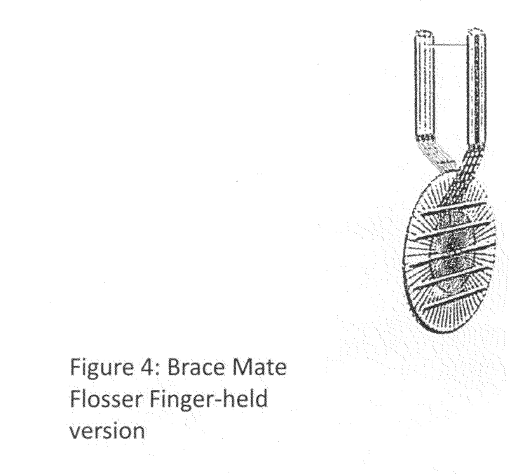

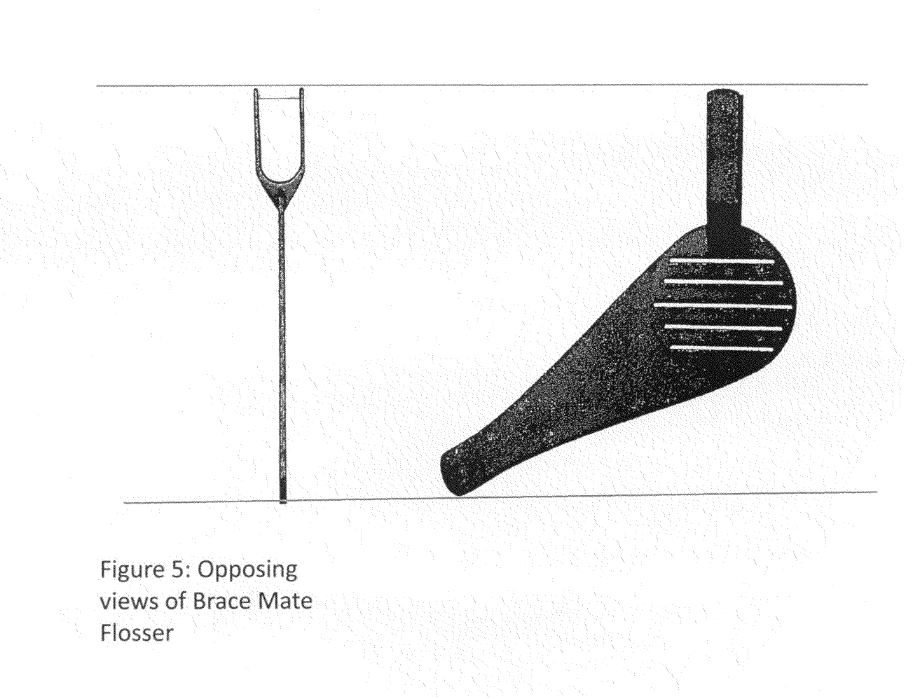

FIGS. 1-4 illustrate dental flossing device 10. Flossing device 10 comprises a flat, elongated textured grip ending in a narrow, U-shaped floss holder with equal sized, opposing, extensions that easily fit between the orthodontic wire brace and the tooth; a strand of dental floss stretched and permanently secured taught between each opposing distal end of the U-shaped floss holder, wherein the elongated textured grip extends away from the U-shaped floss holder at an angle of approximately 120° to permit easy user grip, insertion and fulcrum-like control. Grip 12 extends from base 13 of dental flossing device 10. U-shaped flosser holder 14 extends obtusely between about 90 degrees and about 110 degrees from grip 12. U-shaped flosser holder 14 holds floss 15. The flat, elongated, angled, textured grip acts as a fulcrum. In one embodiment, brush 16 extends from arm 18 at end 19 of grip 12.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A dental flossing device comprising of:
(a) a flat, elongated textured grip ending in a narrow, U-shaped floss holder with equal sized, opposing, extensions that easily fit between the orthodontic wire brace and the tooth.
(b) a strand of dental floss stretched and permanently secured taught between each opposing distal end of the U-shaped floss holder.
(c) wherein said elongated textured grip extends away from the U-shaped floss holder at an angle of approximately 120° to permit easy user grip, insertion and fulcrum-like control.

2. A dental flossing device according to claim 1 wherein each opposing end of the U-shaped floss holder equally fit between the orthodontic braces wire and the tooth surface permitting equal use on both sides of the mouth and on upper and lower teeth.

3. A dental flossing device according to claim 1 wherein the textured grip extends about 48 mm to about 54 mm from the base of the flosser.

4. A second embodiment of said dental flossing device according to claim 1, and further defined by said main arm ending in a interproximal (proxy) brush opposite from the U-shaped flosser.

5. A third embodiment of said dental flossing device according to claim 1, where the grip comprises a round or pear-shaped, textured extension extending from the U-shaped flosser.

6. A dental flossing device according to claim 1 wherein the U-shaped floss holder extends obtusely between about 90 degrees and about 110 degrees from the grip as further described in claims 3 and 4.

7. A dental flossing device according to claim 1 wherein the U-shaped floss holder is orthogonal to the elongated textured grip as described in claims 3 and 4.

8. A dental flossing device according to claim 1 wherein an about 15 mm to about 18 mm strand of dental floss is stretched taught and permanently imbedded into the opposing ends of a U-shaped flosser.

9. A dental flossing device according to claim 1 wherein dental floss may be introduced between adjacent teeth and under the metal wire of orthodontic braces by means of two narrow floss holders.

10. A dental flossing device according to claim 1 whereas the flat, elongated, angled, textured grip acts as a fulcrum.

11. A dental flossing device according to claim 1 whereas the flat, elongated, angled, textured grip extends orthogonally away from the U-shaped floss holder to enable easy flossing of rear teeth within the open mouth without hyper-extending the cheek.

12. A dental flossing device according to claim 1 whereas the flat ends of the U-shaped flosser are made of rigid plastic and measure between about 2 mm to about 2.5 mm by about 1 mm to about 1.5 mm permitting easy access between the tooth surface and the wire of the braces.

13. A dental flossing device according to claim 1 whereas the flat ends of the U-shaped flosser extend about 14 mm to about 16 mm from the end of the flat, elongated, angled, textured grip.

14. A dental flossing device according to claim 1 whereas the flat ends of the U-shaped are supported by a thick ridge-like spine providing the support and strength necessary to maintain its U-shape and tension of the floss during insertion between teeth.

15. A method for flossing teeth comprising of:
(a) gripping a rigid, plastic flossing device having a vertically flat main arm and a U-shaped, floss holder with narrow extensions, extending orthogonally upward from the handle between about 90 degrees and about 110 degrees.
(b) Using the angled handle as a fulcrum to push a tightly and permanently attached strand of floss suspended between the two arms of the U-shaped flosser between two adjacent teeth and beneath the orthodontic braces wire that is attached to the tooth surface.
(c) Gripping the rigid, plastic flossing device with the thumb and forefinger and pushing forward and upward at the same time for upper teeth and turning the handle over and pushing downward and forward for lower teeth.
